(19) United States
(12) Patent Application Publication
(10) Pub. No.: US 2009/0161295 A1
(43) Pub. Date: Jun. 25, 2009

(54) ELECTROLYSIS SOLUTION AND ELECTROLYTIC CAPACITOR USING THE SAME

(75) Inventors: Shinsuke Kuroda, Kyoto (JP); Shinya Sasada, Kyoto (JP); Kazumitsu Honda, Osaka (JP); Keiko Hamada, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: SANYO CHEMICAL INDUSTRIES, LTD., Kyoto-shi, Kyoto (JP); MATSUSHITA ELECTRIC INDUSTRIAL CO., LTD., Kadoma-shi, Osaka (JP)

(21) Appl. No.: 12/090,161

(22) PCT Filed: Oct. 16, 2006
(86) PCT No.: PCT/JP2006/320558

§ 371 Date: Oct. 31, 2008

(30) Foreign Application Priority Data
Oct. 17, 2005 (JP) 2005-301939

(51) Int. Cl. H01G 9/02; H01G 9/022

(52) U.S. Cl. 361/505; 252/62.2

(57) ABSTRACT

The present invention has its object to provide an electrolyte anion which is high in decomposition temperature, in order to inhibit the electrolyte anion in the electrolyte solution for electrolytic capacitors from undergoing decarboxylation in the lead-free solder reflowing step to thereby prevent valve opening.

The present invention uses an electrolyte solution comprising, as an electrolyte, the salt (A) composed of ammonium cation (a) and a polybasic carboxylic acid (b) anion, wherein the proton part charge of each carboxyl group in the polybasic carboxylic acid (b) as calculated by the quantum mechanics calculation software CAChe-based AM1 method is not higher than 0.243. Preferred is the polybasic carboxylic acid (b) represented by the general formula (1):

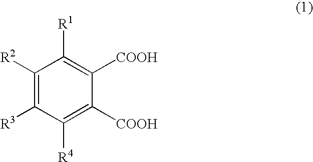

wherein R¹ to R⁴ may be the same or different and each represents a hydrogen atom, a functional group or a hydrocarbon group containing 1 to 3 carbon atoms, which may optionally contain a functional group, provided that at least one of R¹ to R⁴ is an electron-donating group.

### TECHNICAL FIELD

The present invention relates to an electrolyte solution for electrolytic capacitors and to an electrolytic capacitor using the same.

### BACKGROUND ART

Known in the art as electrolyte solutions for electrolytic capacitors are electrolyte solutions prepared by dissolving such an electrolyte as the ammonium salt of a carboxylic acid, typically maleic acid or citraconic acid, in γ-butyrolactone or ethylene glycol (e.g. Patent Document 1) and electrolyte solutions prepared by dissolving, in γ-butyrolactone or ethylene glycol, a carboxylic acid salt of the quaternization product derived from an alkyl-substituted amidine group-containing compound (e.g. Patent Document 2).

A recent trend toward reductions in consumption of environment-unfriendly substances has been expediting the use of lead-free solders. To cope with the lead-free solders, it is necessary to raise the temperature in the step of reflowing to 260° C. In the electrolytic capacitors in which the conventional electrolyte solutions are used, however, the carboxylate anion undergoes decarboxylation due to the heat in the solder reflowing oven (e.g. at 260° C.), so that a problem arises then, namely valve opening occurs.

Patent Document 1: U.S. Pat. No. 4,715,976, Specification (page 1)

Patent Document 2: WO95/15572 (page 1)

### SUMMARY OF THE INVENTION

Thus, it is an object of the present invention to solve such prior art problems as mentioned above and provide an electrolyte solution for electrolytic capacitors which inhibits the carboxylate anion from undergoing decarboxylation due to the heat (260° C.) in the solder reflowing oven to thereby prevent valve opening, and an electrolytic capacitor using the same.

The present inventors made intensive investigations to solve the problems mentioned above and, as a result, have now completed the present invention. Thus, the present invention consists in an electrolyte solution comprising, as an electrolyte, the salt (A) composed of an onium cation (a) and a polybasic carboxylic acid (b) anion, wherein the proton part charge of each carboxyl group in the polybasic carboxylic acid (b) as calculated by the quantum mechanics calculation software CAChe-based AM1 method is not higher than 0.243.

### DETAILED DESCRIPTION OF THE INVENTION

As the onium cation (a) to be used in the practice of the invention, there maybe mentioned quaternized ammonium cations, amidinium cations and guanidinium cations, among others. From the decomposition temperature viewpoint, amidinium cations and guanidinium cations are preferred, and cyclic amidinium cations and cyclic guanidinium cations are more preferred. Among the cyclic amidinium cations and cyclic guanidinium cations, those having a 5- or 6-membered ring are particularly preferred.

Examples of the amidinium cation are as follows.

### [1] Imidazoliniums

1,2,3,4-Tetramethylimidazolinium, 1,3,4-trimethyl-2-ethylimidazolinium, 1,3-dimethyl-2,4-diethylimidazolinium, 1,2-dimethyl-3,4-diethylimidazolinium, 1-methyl-2,3,4-triethylimidazolinium, 1,2,3,4-tetraethylimidazolinium, 1,2,3-trimethylimidazolinium, 1,3-dimethyl-2-ethylimidazolinium, 1-ethyl-2,3-dimethylimidazolinium, 1,2,3-triethylimidazolinium, 4-cyano-1,2,3-trimethylimidazolinium, 3-cyanomethyl-1,2-dimethylimidazolinium, 2-cyanomethyl-1,3-dimethylimidazolinium, 4-acetyl-1,2,3-trimethylimidazolinium, 3-acetylmethyl-1,2-dimethylimidazolinium, 4-methylcarbooxymethyl-1,2,3-trimethylimidazolium, 3-methylcarbooxymethyl-1,2-dimethylimidazolinium, 4-methoxy-1,2,3-trimethylimidazolinium, 3-methoxymethyl-1,2-dimethylimidazolinium, 4-formyl-1,2,3-trimethylimidazolinium, 3-formyl-1,2-dimethylimidazolinium, 3-hydroxyethyl-1,2-dimethylimidazolinium, 4-hydroxymethyl-1,2,3-trimethylimidazolinium, 2-hydroxyethyl-1,3-dimethylimidazolinium, etc.

### [2] Imidazoliums

1,3-Dimethylimidazolium, 1,3-diethylimidazolium, 1-ethyl-3-methylimidazolium, 1,2,3-trimethylimidazolium, 1,2,3,4-tetramethylimidazolium, 1,3-dimethyl-2-ethylimidazolium, 1,2-dimethyl-3-ethylimidazolium, 1,2,3-triethylimidazolium, 1,2,3,4-tetraethylimidazolium, 1,3-dimethyl-2-phenylimidazolium, 1,3-dimethyl-2-benzylimidazolium, 1-benzyl-2,3-dimethylimidazolium, 4-cyano-1,2,3-trimethylimidazolium, 3-cyanomethyl-1,2-dimethylimidazolium, 2-cyanomethyl-1,3-dimethylimidazolium, 4-acetyl-1,2,3-trimethylimidazolium, 3-acetylmethyl-1,2-dimethylimidazolium, 4-methylcarbooxymethyl-1,2,3-trimethylimidazolium, 3-methylcabooxymethyl-1,2-dimethylimidazolium, 4-methoxy-1,2,3-trimethylimidazolium, 3-methoxymethyl-1,2-dimethylimidazolium, 4-formyl-1,2,3-trimethylimidazolium, 3-formylmethyl-1,2-dimethylimidazolium, 3-hydroxyethyl-1,2-dimethylimidazolium, 4-hydroxymethyl-1,2,3-trimethylimidazolium, 2-hydroxyethyl-1,3-dimethylimidazolium, etc.

### [3] Tetrahydropyrimidiniums

1,3-Dimethyl-1,4,5,6-tetrahydropyrimidinium, 1,2,3-trimethyl-1,4,5,6,-tetrahydropyrimidinium, 1,2,3,4-tetramethyl-1,4,5,6-tetrahydropyrimidinium, 1,2,3,5-tetramethyl-1,4,5,6-tetrahydropyrimidinium, 8-methyl-1,8-diazabicyclo[5.4.0]-7-undecenium, 5-methyl-1,5-diazabicyclo[4.3.0]-5-nonenium, 4-cyano-1,2,3-trimethyl-1,4,5,6-tetrahydropyrimidinium, 3-cyanomethyl-1,2-dimethyl-1,4,5,6-tetrahydropyrimidinium, 2-cyanomethyl-1,3-dimethyl-1,4,5,6-tetrahydropyrimidinium, 4-acetyl-1,2,3-trimethyl-1,4,5,6-tetrahydropyrimidinium, 3-acetylmethyl-1,2-dimethyl-1,4,5,6-tetrahydropyrimidinium, 4-methylcarbooxymethyl-1,2,3-trimethyl-1,4,5,6-tetrahydropyrimidinium, 3-methylcarbooxymethyl-1,2-dimethyl-1,4,5,6-tetrahydropyrimidinium, 4-methoxy-1,2,3-trimethyl-1,4,5,6-tetrahydropyrimidinium, 3-methoxymethyl-1,2-dimethyl-1,4,5,6-tetrahydropyrimidinium, 4-formyl-1,2,3-trimethyl-1,4,5,6-tetrahydropyrimidinium, 3-formylmethyl-1,2-dimethyl-1,4,5,6-tetrahydropyrimidinium, 3-hydroxyethyl-1,2-dimethyl-1,4,5,6-tetrahydropyrimidinium, 4-hydroxymethyl-1,2,3-trimethyl-1,4,5,6-tetrahydropyrimidinium, 2-hydroxyethyl-1,3-dimethyl-1,4,5,6-tetrahydropyrimidinium, etc.

### [4] Dihydropyrimidiniums

1,3-Dimethyl-1,4- or -1,6-dihydropyrimidinium [these are collectively referred to as 1,3-dimethyl-1,4(6)-dihydropyrimidinium; hereinafter the same shall apply], 1,2,3-trimethyl-1,4(6) -dihydropyrimidinium, 1,2,3,4-tetramethyl-1,4(6)-dihydropyrimidinium, 1,2,3,5-tetramethyl-1,4(6)-dihydropyrimidinium, 8-methyl-1,8-diazabicyclo[5.4.0]-7,9(10) -undecadienium, 5-methyl-1,5-diazabicyclo[4.3.0]-5,7(8)-nonadienium, 4-cyano-1,2,3-trimethyl-1,4(6)-dihydropyrimidinium, 3-cyanomethyl-1,2-dimethyl-1,4(6)-dihydropyrimidinium, 2-cyanomethyl-1,3-dimethyl-1,4(6)-dihydropyrimidinium, 4-acetyl-1,2,3-trimethyl-1,4(6)-dihydropyrimidinium, 3-acetylmethyl-1,2-dimethyl-1,4(6) -dihydropyrimidinium, 4-methylcarbooxymethyl-1,2,3-trimethyl-1,4(6)-dihydropyrimidinium, 3-methylcarbooxymethyl-1,2-dimethyl-1,4(6)-dihydropyrimidinium, 4-methoxy-1,2,3-trimethyl-1,4(6)-dihydropyrimidinium, 3-methoxymethyl-1,2-dimethyl-1,4(6)-dihydropyrimidinium, 4-formyl-1,2,3-trimethyl-1,4(6) -dihydropyrimidinium, 3-formylmethyl-1,2-dimethyl-1,4(6)-dihydropyrimidinium, 3-hydroxyethyl-1,2-dimethyl-1,4(6)-dihydropyrimidinium, 4-hydroxymethyl-1,2,3-trimethyl-1,4(6)-dihydropyrimidinium, 2-hydroxyethyl-1,3-dimethyl-1,4(6)-dihydropyrimidinium, etc.

Examples of the guanidinium cation are as follows.

[1] Guanidiniums having an Imidazolinium Skeleton

2-Dimethylamino-1,3,4-trimethylimidazolinium, 2-diethylamino-1,3,4-trimethylimidazolinium, 2-diethylamino-1,3-dimethyl-4-ethylimidazolinium, 2-dimethylamino-1-methyl-3,4-diethylimidazolinium, 2-diethylamino-1-methyl-3,4-diethylimidazolinium, 2-diethylamino-1,3,4-triethylimidazolinium, 2-dimethylamino-1,3-dimethylimidazolinium, 2-diethylamino-1,3-dimethylimidazolinium, 2-dimethylamino-1-ethyl-3-methylimidazolinium, 2-diethylamino-1,3-diethylimidazolinium, 1,5,6,7-tetrahydro-1,2-dimethyl-2H-imido[1,2a]imidazolinium, 1,5-dihydro-1,2-dimethyl-2H-imido[1,2a]imidazolinium, 1,5,6,7-tetrahydro-1,2-dimethyl-2H-pyrimido[1,2a]imidazolinium, 1,5-dihydro-1,2-dimethyl-2H-pyrimido[1,2a]imidazolinium, 2-dimethylamino-4-cyano-1,3-dimethylimidazolinium, 2-dimethylamino-3-cyanomethyl-1-methylimidazolinium, 2-dimethylamino-4-acetyl-1,3-dimethylimidazolinium, 2-dimethylamino-3-acetylmethyl-1-methylimidazolinium, 2-dimethylamino-4-methylcarbooxymethyl-1,3-dimethylimidazolinium, 2-dimethylamino-3-methylcarbooxymethyl-1-methylimidazolinium, 2-dimethylamino-4-methoxy-1,3-dimethylimidazolinium, 2-dimethylamino-3-methoxymethyl-1-methylimidazolinium, 2-dimethylamino-4-formyl-1,3-dimethylimidazolinium, 2-dimethylamino-3-formylmethyl-1-methylimidazolinium, 2-dimethylamino-3-hydroxyethyl-1-methylimidazolinium, 2-dimethylamino-4-hydroxymethyl-1,3-dimethylimidazolinium, etc.

[2] Guanidiniums having an Imidazolium Skeleton

2-Dimethylamino-1,3,4-trimethylimidazolium, 2-diethylamino-1,3,4-trimethylimidazolium, 2-diethylamino-1,3-dimethyl-4-ethylimidazolium, 2-dimethylamino-1-methyl-3,4-diethylimidazolium, 2-diethylamino-1-methyl-3,4-diethylimidazolium, 2-diethylamino-1,3,4-triethylimidazolium, 2-dimethylamino-1,3-dimethylimidazolium, 2-diethylamino-1,3-dimethylimidazolium, 2-dimethylamino-1-ethyl-3-methylimidazolium, 2-diethylamino-1,3-diethylimidazolium, 1,5,6,7-tetrahydro-1,2-dimethyl-2H-imido[1,2a]imidazolium, 1,5-dihydro-1,2-dimethyl-2H-imido[1,2a]imidazolium, 1,5,6,7-tetrahydro-1,2-dimethyl-2H-pyrimido[1,2a]imidazolium, 1,5-dihydro-1,2-dimethyl-2H-pyrimido[1,2a]imidazolium, 2-dimethylamino-4-cyano-1,3-dimethylimidazolium, 2-dimethylamino-3-cyanomethyl-1-methylimidazolium, 2-dimethyalmino-4-acetyl-1,3-dimethylimidazolium, 2-dimethylamino-3-acetylmethyl-1-methylimidazolium, 2-dimethylamino-4-methylcarbooxymethyl-1,3-dimethylimidazolium, 2-dimethylamino-3-methylcarbooxymethyl-1-methylimidazolium, 2-dimethylamino-4-methoxy-1,3-dimethylimidazolium, 2-dimethylamino-3-methoxymethyl-1-methylimidazolium, 2-dimethylamino-4-formyl-1,3-dimethylimidazolium, 2-dimethylamino-3-formylmethyl-1-methylimidazolium, 2-dimethylamino-3-hydroxyethyl-1-methylimidazolium, 2-dimethylamino-4-hydroxymethyl-1,3-dimethylimidazolium, etc.

[3] Guanidiniums having a Tetrahydropyrimidinium Skeleton

2-Dimethylamino-1,3,4-trimethyl-1,4,5,6-tetrahydropyrimidinium, 2-diethylamino-1,3,4-trimethyl-1,4,5,6-tetrahydropyrimidinium, 2-diethylamino-1,3-dimethyl-4-ethyl-1,4,5,6-tetrahydropyrimidinium, 2-dimethylamino-1-methyl-3,4-diethyl-1,4,5,6-tetrahydropyrimidinium, 2-diethylamino-1-methyl-3,4-diethyl-1,4,5,6-tetrahydropyrimidium, 2-diethylamino-1,3,4-triethyl-1,4,5,6-tetrahydropyrimidinium, 2-dimethylamino-1,3-dimethyl-1,4,5,6-tetrahydropyrimidinium, 2-diethylamino-1,3-dimethyl-1,4,5,6-tetrahydropyrimidinium, 2-dimethylamino-1-ethyl-3-methyl-1,4,5,6-tetrahydropyrimidinium, 2-diethylamino-1,3-diethyl-1,4,5,6-tetrahydropyrimidinium, 1,3,4,6,7,8-hexahydro-1,2-dimethyl-2H-imido[1,2a]pyrimidinium, 1,3,4,6-tetrahydro-1,2-dimethyl-2H-imido[1,2a]pyrimidinium, 1,3,4,6,7,8-hexahydro-1,2-dimethyl-2H-pyrimido[1,2a]pyrimidinium, 1,3,4,6-tetrahydro-1,2-dimethyl-2H-pyrimido[1,2a]pyrimidinium, 2-dimethylamino-4-cyano-1,3-dimethyl-1,4,5,6-tetrahydropyrimidinium, 2-dimethylamino-3-cyanomethyl-1-methyl-1,4,5,6-tetrahydropyrimidinium, 2-dimethylamino-4-acetyl-1,3-dimethyl-1,4,5,6-tetrahydropyrimidinium, 2-dimethylamino-3-acetylmethyl-1-methyl-1,4,5,6-tetrahydropyrimidinium, 2-dimethylamino-4-methylcarbooxymethyl-1,3-dimethyl-1,4,5,6-tetrahydropyrimidinium, 2-dimethylamino-3-methylcarbooxymethyl-1-methyl-1,4,5,6-tetrahydropyrimidinium, 2-dimethylamino-4-methoxy-1,3-dimethyl-1,4,5,6-tetrahydropyrimidinium, 2-dimethylamino-3-methoxymethyl-1-methyl-1,4,5,6-tetrahydropyrimidinium, 2-dimethylamino-4-formyl-1,3-dimethyl-1,4,5,6-tetrahydropyrimidinium, 2-dimethylamino-3-formylmethyl-1-methyl-1,4,5,6-tetrahydropyrimidinium, 2-dimethylamino-3-hydroxyethyl-1-methyl-1,4,5,6-tetrahydropyrimidinium, 2-dimethylamino-4-hydroxymethyl-1,3-dimethyl-1,4,5,6-tetrahydropyrimidinium, etc.

[4] Guanidiniums having a Dihydropyrimidinium Skeleton

2-Dimethylamino-1,3,4-trimethyl-1,4(6)-dihydropyrimidinium, 2-diethylamino-1,3,4-trimethyl-1,4(6)-dihydropyrimidinium, 2-diethylamino-1,3-dimethyl-4-ethyl-1,4(6)-dihydropyrimidinium, 2-dimethylamino-1-methyl-3,4-diethyl-1,4(6)-dihydropyrimidinium, 2-diethylamino-1-methyl-3,4-diethyl-1,4(6)-dihydropyrimidinium, 2-diethylamino-1,3,4-triethyl-1,4(6)-dihydropyrimidinium, 2-dimethylamino-1,3-dimethyl-1,4(6)-dihydropyrimidinium, 2-diethylamino-1,3-dimethyl-1,4(6) -dihydropyrimidinium, 2-dimethylamino-1-ethyl-3-methyl-1,4(6)-dihydropyrimidinium, 2-diethylamino-1,3-diethyl-1,4(6)-dihydropyrimidinium, 1,6,7,8-tetrahydro-1,2-dimethyl-2H-imido[1,2a]pyrimidinium, 1,6-dihydro-1,2-dimethyl-2H-imido[1,2a]pyrimidinium, 1,6,7,8-tetrahydro-1,2-dimethyl-2H-pyrimido[1,2a]pyrimidinium, 1,6-dihydro-1,2-dimethyl-2H-pyrimido[1,2a]pyrimidinium, 2-dimethylamino-4-cyano-1,3-dimethyl-1,4(6)-dihydropyrimidinium, 2-dimethylamino-3-cyanomethyl-1-methyl-1,4(6)-dihydropyrimidinium, 2-dimethylamino-4-acetyl-1,3-dimethyl-1,4(6)-dihydropyrimidinium, 2-dimethylamino-4-acetylmethyl-1-methyl-1,4(6)-dihydropyrimidinium, 2-dimethylamino-4-methylcarbooxymethyl-1,3-dimethyl-1,4(6)-dihydropyrimidinium, 2-dimethylamino-3-methylcarbooxymethyl-1-methyl-1,4(6)-dihydropyrimidinium, 2-dimethylamino-4-methoxy-1,3-dimethyl-1,4(6)-dihydropyrimidinium, 2-dimethylamino-3-methoxymethyl-1-methyl-1,4(6)-dihydropyrimidinium, 2-dimethylamino-4-formyl-1,3-dimethyl-1,4(6)-dihydropyrimidinium, 2-dimethylamino-3-formylmethyl-1-methyl-1,4(6)-dihydropyrimidinium, 2-dimethylamino-3-hydroxyethyl-1-methyl-1,4(6)-dihydropyrimidinium, 2-dimethylamino-4-hydroxymethyl-1,3-dimethyl-1,4(6)-dihydropyrimidinium, etc.

The amidiniums and guanidiniums mentioned above may be used singly or two or more of them may be used in combination. Among the amidiniums and guanidiniums mentioned above, the amidiniums are preferred, the imidazoliniums and imidazoliums are more preferred, and 1-ethyl-3-methylimidazolium, 1,2,3,4-tetramethylimidazolinium and 1-ethyl-2,3-dimethylimidazolinium are most preferred.

The decarboxylation of the carboxylate anion of the electrolyte in an electrolyte solution is presumably triggered by the carbonyl group oxygen atom of the carboxylic acid attacking the proton in the carboxyl group of another carboxylic acid molecule. Therefore, the decarboxylation can be inhibited by prescribing that the maximum carboxyl group proton part charge should be at a low level (not higher than 0.243) so that the attack of the proton of the carboxyl group by the carbonyl group oxygen atom may be inhibited. For restricting the maximum value of the proton part charge of the carboxyl group to a low level, there is a method available which comprises introducing an electron-donating group into the α position in aliphatic polybasic carboxylic acids or either into the ortho position or into the para position in aromatic polybasic carboxylic acids.

Each carboxyl group in the polybasic carboxylic acid (b) constituting the electrolyte in the electrolyte solution according to the invention has a proton part charge of not higher than 0.243, preferably 0.240 to 0.243. When that partial charge is in excess of 0.243, the carbonyl group oxygen atom can readily attack the carboxyl group proton to promote decarboxylation. So long as the charge is not lower than 0.240, the degree of dissociation of the electrolyte salt in the electrolyte solution will not lower, hence there is no fear of the electric conductivity of the electrolyte solution becoming reduced.

The partial charge in question is calculated by the quantum mechanics calculation software CAChe-based AM1 method. The calculation by the CAChe-based AM1 method can be carried out using Fujitsu's CAChe WORKSYSTEM 5.02, for instance. The partial charge can be calculated by depicting the molecular structure, for which the calculation is to be made, on WorkSpace, followed by structural optimization by means of AM1 geometry. In the structural optimization, semiempirical parameters are selected based on the initial structure, and the energy of the molecule and the forces exerted on atoms are calculated in the manner of quantum chemistry calculation. The AM1 method is one of semiempirical molecular orbit methods in which the integrals necessary for calculation are determined from experimental values; it can determine partial charges in vacuum.

The AM1 method mentioned above is based on the calculation method described in J. Am. Chem. Soc., 107, 3902 (1985) and Bunshi Kidoho MO PAC Gaidobukku (Molecular Orbital Method MO PAC Guidebook) (second revised edition, published Sep. 15, 1994 by Kaibundo Shuppan).

As the polybasic carboxylic acid (b), there may be mentioned, for example, aliphatic dicarboxylic acids having an electron-donating group in the α-position [e.g. α-methylsuccinic acid, α-phenylsuccinic acid, α-methoxyadipic acid, α-aminoadipic acid, etc.] and aromatic polybasic carboxylic acids having an electron-donating group in the position ortho or para to a carboxyl group [e.g. 4-methylphthalic acid, 4-acetoxyphthalic acid, 4-methylisophthalic acid, 3-methylpyromellic acid, 3-methoxypyromellitic acid, etc.].

Preferred as the polybasic carboxylic acid (b) are dicarboxylic acid.

Preferred examples of the polybasic carboxylic acid (b) are polybasic carboxylic acids having a structure (1) represented by the following formula (I).

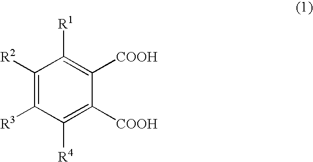

[In the above formula, R¹ to R⁴ may be the same or different and each represents a hydrogen atom, a functional group or a hydrocarbon group containing 1 to 3 carbon atoms, which may optionally contain a functional group, provided that at least one of R¹ to R⁴ is an electron-donating group.]

In the polybasic carboxylic acids having the above structure of formula (1), at least one of R¹ to R⁴ is a hydrogen atom, a functional group, or a hydrocarbon group containing 1 to 3 carbon atoms, which may optionally contain a functional group, and at least one of them is an electron-donating group.

As the functional group, there may be mentioned, for example, an allyl group, an ether group, an ester group, a hydroxyl group, an amino group, an alkoxy group containing 1 to 5 carbon atoms (e.g. a methoxy group, an ethoxy group, etc.), an acetyl group, an acetoxy group, a nitrile group, a phenyl group, etc.

As the hydrocarbon group containing 1 to 3 carbon atoms, which may optionally have a functional group, there may be mentioned, for example, a methylamino group, an ethylamino group, a propylamino group, a hydroxymethyl group, a hydroxyethyl group, a hydroxypropyl group and so forth.

As the electron-donating group, there may be mentioned alkyl groups containing 1 to 5 carbon atoms (e.g. a methyl group, an ethyl group, a propyl group, etc.), an amino group, a phenyl group, an alkoxy group containing 1 to 5 carbon atoms (e.g. a methoxy group, an ethoxy group, etc.), and an acetoxy group. At least one group selected from the group consisting of a methyl group, an ethyl group, a propyl group, an amino group, a phenyl group, an acetoxy group and a methoxy group is preferred and, from the electric conductivity viewpoint, a methyl group is more preferred.

As preferred examples of the polybasic carboxylic acid (b) to be used in the practice of the invention, there may be mentioned the following: 3-methylphthalic acid, 3-ethylphthalic acid, 3-propylphthalic acid, 3-phenylphthalic acid, 3-aminophthalic acid, 3-methoxyphthalic acid, 4-methylphthalic acid, 4-ethylphthalic acid, 4-propylphthalic acid, 4-phenylphthalic acid, 4-aminophthalic acid, 4-methoxyphthalic acid, etc. Among these, 3-methylphthalic acid and 4-methylphthalic acid are more preferred.

In the practice of the invention, the polybasic carboxylic acid (b) may comprise one single species or a combination of two or more species.

From the viewpoint of solubility of the salt (A) in an electrolyte solvent and of thermal stability, the acid (b) preferably has a molecular weight of 114 to 500, more preferably 114 to 300.

The salt (A) in the electrolyte solution according to the invention is constituted of the onium cation (a) and the anion derived from the polybasic carboxylic acid (b).

As for the method of preparing the salt (A), mention may be made, for example, of the method which comprises quaternizing a tertiary amine with dimethyl carbonate, followed by acid exchange, as described in WO 95/15572.

From the electric conductivity and thermal stability points of view, the equivalent ratio between the cation (a) and acid (b) in the electrolyte constituting the electrolyte solution according to the invention is preferably (a):(b) 1:0.5 to 1:2, more preferably (a):(b)=1:0.5 to 1:1.5, particularly preferably (a):(b)=1:0.8 to 1:1.2.

In view of electric conductivity of the salt (A) and of solubility thereof in an electrolyte solvent, the content of the salt (A) in the electrolyte solution according to the invention is preferably 5 to 70% by weight, more preferably 5 to 40% by weight, particularly preferably 10 to 30% by weight.

The electrolyte solution according to the invention preferably occurs as a solution of the salt (A) in a solvent. The solvent is not particularly restricted but may be an organic solvent per se known in the art. Specific examples of the organic solvent are listed below; two or more of them may also be used in combination. Further, water may be used in combination with such an organic solvent according to need.

Alcohols:

Monohydric alcohols; monohydric alcohols containing 1 to 6 carbon atoms (methyl alcohol, ethyl alcohol, propyl alcohol, butyl alcohol, diacetone alcohol, furfuryl alcohol, etc.) and monohydric alcohols containing 7 or more carbon atoms (benzyl alcohol, octanol, etc.);

Dihydric alcohols; dihydric alcohols containing 1 to 6 carbon atoms (ethylene glycol, propylene glycol, diethylene glycol, hexylene glycol, etc.) and dihydric alcohols containing 7 or more carbon atoms (octylene glycol etc.);

Trihydric alcohols; trihydric alcohols containing 1 to 6 carbon atoms (glycerol etc.);

Tetra- to hexahydric or further polyhydric alcohols; tetra- to hexahydric or further polyhydric alcohols containing 1 to 6 carbon atoms (hexitol etc.) and so forth;

Ethers;

Monoethers (ethylene glycol monomethyl ether, ethylene glycol monoethyl ether, diethylene glycol monomethyl ether, diethylene glycol monoethyl ether, ethylene glycol monophenyl ether, tetrahydrofuran, 3-methyltetrahydrofuran, etc.), diethers (ethylene glycol dimethyl ether, ethylene glycol diethyl ether, diethylene glycol dimethyl ether, diethylene glycol diethyl ether, etc.), etc.;

Amides;

Formamides (N-methylformamides, N,N-dimethylformamide, N-ethylformamide, N,N-diethylformamide, etc.), acetamides (N-methylacetamide, N,N-dimethylacetamide, N-ethylacetamide, N,N-diethylacetamide, etc.), propionamides (N,N-dimethylpropionamide etc.), hexamethylphosphorylamide, etc.;

Oxazolidinones;

N-Methyl-2-oxazolidinone, 3,5-dimethyl-2-oxazolidinone, etc.;

Lactones;

γ-Butyrolactone, α-acetyl-γ-butyrolactone, β-butyrolactone, γ-valerolactone, δ-valerolactone, etc.;

Nitriles;

Acetonitrile, acrylonitrile, etc.;

Carbonates;

Ethylene carbonate, propylene carbonate, etc.;

Other Organic Solvents;

Dimethyl sulfoxide, sulfolane, 1,3-dimethyl-2-imidazolidinone, N-methylpyrrolidone, aromatic solvents (toluene, xylene, etc.), paraffinic solvents (normalparaffins, isoparaffins), etc.

Preferred among these solvents for use in electrolyte solutions for electrolytic capacitors are alcohol- and/or lactone-based solvents; particularly preferred are γ-butyrolactone- and/or ethylene glycol-based solvents.

The content of the solvent in the electrolyte solution according to the invention preferably 30 to 95% by weight, more preferably 50 to 90% by weight, based on the weight of the electrolyte solution.

From the electric conductivity viewpoint, the content of water in case of the combined use of a solvent and water is generally not higher than 50% by weight, preferably not higher than 10% by weight, based on the weight of the electrolyte solution.

The electrolyte solution according to the invention preferably has a pH of 3 to 12, more preferably 6 to 11 and, on the occasion of preparing the salt (A), the conditions (e.g. anion species, use amount conditions) are selected so that the pH of the electrolyte solution may fall within the above range. For example, when a partial ester of a polybasic acid such as a polycarboxylic acid is used as the anion component, it is necessary to pay attention to pH adjustment. The above-mentioned pH of the electrolyte solution is the value obtained by analyzing the electrolyte solution at 25° C.

In the electrolyte solution according to the invention, there may be incorporated, according to need, one or more of various additives generally used in electrolyte solutions. As such additives, there may be mentioned phosphoric acid derivatives (e.g. phosphoric acid, phosphate esters, etc.), boric acid derivatives (e.g. boric acid, complexes between boric acid and polysaccharides [mannitol, sorbitol, etc.], complexes between boric acid and polyhydric alcohols [ethylene glycol, glycerol, etc.], nitro compounds (e.g. o-nitrobenzoic acid, p-nitrobenzoic acid, m-nitrobenzoic acid, o-nitrophenol, p-nitrophenol, etc.) and so forth. From the viewpoint of electric conductivity and solubility, in electrolyte solvents, of the salt (A), the level of addition of the additives is preferably not higher than 10% by weight relative to the salt (A).

The electrolyte solution according to the invention is used in an electrolytic capacitor. The electrolytic capacitor is not particularly restricted but may comprise, for example, a capacitor element intended for use in a rolled-up type aluminum electrolytic capacitor and constructed by rolling up a stack constituted of an anode foil having an aluminum oxide surface layer and a cathode aluminum foil with a separator disposed therebetween. An aluminum electrolytic capacitor can be constructed by impregnating this element with the electrolyte solution according to the invention as a driving electrolyte solution, housing the thus-impregnated capacitor element in a bottomed cylindrical aluminum casing and hermetically sealing the opening of the aluminum casing with a sealant.

### EFFECT OF THE INVENTION

The electrolytic capacitor in which the electrolyte solution according to the invention is used can be prevented from undergoing carboxylate anion decarboxylation due to heating (e.g. at 260° C.) in a solder reflowing oven and from causing valve opening.

### BEST MODES FOR CARRYING OUT THE INVENTION

Now, several specific examples are given to illustrate the present invention. They are, however, by no means limitative of the scope of the invention.

### Production Example 1

### Production of 1,2,3,4-tetramethylimidazolinium 4-methylphthalate (A-1)

A one-liter SUS stirring autoclave was charged with 270.0 g of dimethyl carbonate and 98.0 g of 1,2,4-trimethylimidazoline, and the reaction was allowed to proceed at a reaction temperature of 130° C. for 24 hours. Thereafter, the autoclave was cooled, and the reaction mixture was analyzed by liquid chromatography; the conversion of 1,2,4-trimethylimidazoline was 95.0%. The unreacted materials and the reaction byproduct methanol were distilled off, whereby 180 g of 1,2,3,4-tetramethylimidazolinium methyl carbonate (a-1) was obtained. A 30-g portion of the 1,2,3,4-tetramethylimidazolinium methyl carbonate obtained was dissolved in 200.0 g of methanol, and 78.6 g of 4-methylphthalic acid was added gradually, whereupon carbon dioxide gas was emitted violently. Degassing and methanol removal at 80° C./20 mmHg gave 48.0 g of 1,2,3,4-tetramethylimidazolinium 4-methylphthalate (A-1).

### Production Example 2

### Production of 1,2,3,4-tetramethylimidazolinium 4-ethylphthalate (A-2)

1,2,3,4-Tetramethylimidazolinium 4-ethylphthalate (A-2; 50.2 g) was obtained in the same manner as in Production Example 1 except that 84.7 g of 4-ethylphthalic acid was used in lieu of 78.6 g of 4-methylphthalic acid.

### Production Example 3

### Production of 1,2,3,4-tetramethylimidazolinium 4-methoxyphthalate (A-3) 1,2,3,4-Tetramethylimidazolinium 4-methoxyphthalate

(A-3; 50.5 g) was obtained in the same manner as in Production Example 1 except that 85.6 g of 4-methoxyphthalic acid was used in lieu of 78.6 g of 4-methylphthalic acid.

### Production Example 4

### Production of 1,2,3,4-tetramethylimidazolinium 3-aminophthalate (A-4)

1,2,3,4-Tetramethylimidazolinium 3-aminophthalate (A-4; 48.2 g) was obtained in the same manner as in Production Example 1 except that 79.0 g of 3-aminophthalic acid was used in lieu of 78.6 g of 4-methylphthalic acid.

### Production Example 5

### Production of 1,2,3,4-tetramethylimidazolinium 3-methylphthalate (A-5)

1,2,3,4-Tetramethylimidazolinium 3-methylphthalate

(A-5; 48.0 g) was obtained in the same manner as in Production Example 1 except that 78.6 g of 3-methylphthalic acid was used in lieu of 78.6 g of 4-methylphthalic acid.

### Comparative Production Example 1

### Production of 1,2,3,4-tetramethylimidazolinium o-phthalate (A-1′)

1,2,3,4-Tetramethylimidazolinium o-phthalate (A-1′); 45.5 g) was obtained in the same manner as in Production Example 1 except that 72.5 g of o-phthalic acid was used in lieu of 78.6 g of 4-methylphthalic acid.

### Examples 1 to 5 and Comparative Example 1

The electrolyte solutions of Examples 1 to 5 and Comparative Example 1 were prepared by formulating 1,2,3,4-tetramethylimidazolinium 4-methylphthalate (A-1), 1,2,3,4-tetramethylimidazolinium 4-ethylphthalate (A-2), 1,2,3,4-tetramethylimidazolinium 4-methoxyphthalate (A-3), 1,2,3,4-tetramethylimidazolinium 3-aminophthalate (A-4), 1,2,3,4-tetramethylimidazolinium 3-methylphthalate (A-5) or 1,2,3,4-tetramethylimidazolinium o-phthalate (A-1′) and commercial-grade γ-butyrolactone (product of Mitsubishi Chemical Corporation) so that the electrolyte concentration might amount to 30% by weight, as shown in Table 1.

For the polybasic carboxylic acids (b) constituting the salts used in Examples 1 to 5 and Comparative Example 1, the carboxylproton charge densities in the acids (b) as calculated by the AM1 method using the quantum-mechanical calculation software CAChe are given in Table 1.

TABLE 1

| | | Electrolyte | Carboxyl group | |
|---|---|---|---|---|
| | | concentration | proton charge | Carbon dioxide |
| Polybasic carboxylic acid (b) | | (% by weight) | density | emission (g) |
| Example 1 | 4-Methylphthalic acid | 30 | 0.243 | 0 |
| Example 2 | 4-Ethylphthalic acid | 30 | 0.243 | 0 |
| Example 3 | 4-Methoxyphthalic acid | 30 | 0.243 | 0 |
| Example 4 | 3-Aminophthalic acid | 30 | 0.240 | 0 |
| Example 5 | 3-Methylphthalic acid | 30 | 0.243 | 0 |
| Compar. Ex. 1 | o-Phthalic acid | 30 | 0.244 | 0.00048 |

### [Level of Carbon Dioxide Emission]

About 0.2 mg of each sample electrolyte solution was allowed to stand in a helium atmosphere at 260° C. for 30 seconds, and the gas emitted during that period was analyzed using a pyrolysis gas chromatograph-mass spectrometer (Shimadzu model QP-2010). The results of the analysis are shown in Table 1. The amount of carbon dioxide emitted per gram of each electrolyte solution was calculated from the area of the peak identified as carbon dioxide based on a working curve constructed using aqueous solutions of ammonium carbonate. The level of carbon dioxide emission as estimated by this method can reflect the gas generation within the capacitor. A higher level of carbon dioxide emission results in an increased capacitor inside pressure, causing swelling of the electrolytic capacitor or valve opening.

As is evident from Table 1, the electrolyte solution of Comparative Example 1 emitted carbon dioxide as a result of thermal decomposition whereas the electrolyte solutions of Examples 1 to 5 did not emit carbon dioxide resulting from thermal decomposition.

Using the electrolyte solutions of Examples 1 to 5 according to the invention and of Comparative Example 1, rolled-up chip aluminum electrolytic capacitors (rated voltage 6.3 V, electrostatic capacity 220 μF, size: Ø 6.3 mm×L 5.8 mm) were constructed. Resin-cured butyl rubber was used as the sealing rubber. A thermal stability evaluation was performed under the reflowing conditions of a top reflow temperature of 255° C., at least 30 seconds at 230° C. and at least 70 seconds at 200° C. The reflowing was carried out twice, and a rubber swelling evaluation was made using digital vernier calipers. The evaluation results are shown in Table 2. Each evaluation result is shown in terms of the mean of measurements of 10 capacitors.

TABLE 2

| | Product swelling after reflowing (mm) |
|---|---|
| Example 1 | 0.07 |
| Example 2 | 0.08 |
| Example 3 | 0.09 |
| Example 4 | 0.09 |
| Example 5 | 0.07 |
| Compar. Ex. 1 | 0.45 |

As is also evident from Table 2, the electrolyte solutions of Examples 1 to 5 according to the invention gave good results with very slight extents of rubber swelling in the products.

The aluminum electrolytic capacitors constructed were allowed to stand at 105° C. and, after the lapse of 2,000 hours, the change in electrostatic capacity (ΔC), the tangent of the loss angle (tan δ) and the leakage current (LC) were measured for each capacitor. The change in weight (AW) of each product was regarded as the tendency of the electrolyte solution to drying up; the evaluation results obtained are shown in Table 3. Each evaluation result is shown in terms of the mean of measurements of 10 capacitors. The change in electrostatic capacity (ΔC), the tangent of the loss angle (tan δ) and the leakage current (LC) were measured by the methods prescribed in the Japanese Industrial Standard JIS C 5102. The product weight measurements were carried out using a Nihon SiberHegner model AG245 electronic balance.

TABLE 3

| | ΔC(%) | Tan δ (%) | LC(μA) | Δw(mg) |
|---|---|---|---|---|
| Example 1 | −18 | 22 | 1.2 | 8.0 |
| Example 2 | −19 | 20 | 1.4 | 9.1 |
| Example 3 | −18 | 21 | 1.3 | 8.9 |
| Example 4 | −17 | 23 | 1.5 | 9.0 |
| Example 5 | −18 | 22 | 1.2 | 8.0 |
| Compar. Ex. 1 | −24 | 26 | 1.5 | 9.8 |

As is evident from Table 3, it was revealed that the electrolyte solutions of Examples 1 to 5 according to the invention can retain good characteristics in all respects even after the lapse of 2,000 hours and their characteristics are comparable or superior to those found in Comparative Example 1.

Further, in an electrolyte leakage test, the rated voltage was applied to the capacitors under humid conditions (85° C., 85% RH) and, after the lapse of 2,000 hours, the sealed portions were observed; the evaluation results are shown in Table 4. Each evaluation result is the mean of measurements of 10 capacitors.

TABLE 4

| | State of sealing rubber |
|---|---|
| | on the negative electrode side |
| | (85° C.-85% RH/2000 hours later) |
| Example 1 | No leakage |
| Example 2 | No leakage |
| Example 3 | No leakage |
| Example 4 | No leakage |
| Example 5 | No leakage |
| Compar. Ex. 1 | No leakage |

As is evident From Table 4, the capacitors of Examples 1 to 5 were never inferior in electrolyte leakage to the capacitor of Comparative Example 1.

The results given above indicate that by using the electrolyte solution according to the invention, it is possible to inhibit rubber swelling on the occasion of reflowing and construct highly reliable aluminum electrolytic capacitors.

### INDUSTRIAL APPLICABILITY

The electrolyte solution according to the invention can be used in electrolytic capacitors and, in particular, can realize highly reliable aluminum electrolytic capacitors stable for a long period of time under high temperature conditions, hence can realize higher performance capacitors; thus, it is of high commercial value.

1. An electrolyte solution comprising, as an electrolyte, the salt (A) composed of an onium cation (a) and a polybasic carboxylic acid (b) anion, wherein the proton part charge of each carboxyl group in the polybasic carboxylic acid (b) as calculated by the quantum mechanics calculation software CAChe-based AM1 method is not higher than 0.243.

2. The electrolyte solution according to claim 1, wherein the polybasic carboxylic acid (b) is a dicarboxylic acid.

3. The electrolytic solution according to claim 1, wherein the polybasic carboxylic acid (b) has a structure represented by the general formula (1): 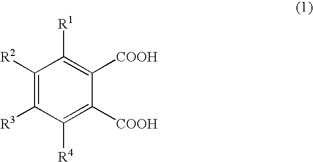
wherein R¹ to R⁴ may be the same or different and each represents a hydrogen atom, a functional group or a hydrocarbon group containing 1 to 3 carbon atoms, which may optionally contain a functional group, provided that at least one of R¹ to R⁴ is an electron-donating group.

4. The electrolyte solution according to claim 3, wherein the electron-donating group is at least one group selected from the group consisting of a methyl group, an ethyl group, a propyl group, an amino group, a phenyl group, an acetoxy group and a methoxy group.

5. The electrolyte solution according to claim 1, wherein the polybasic carboxylic acid (b) is 3-methylphthalic acid or 4-methylphthalic acid.

6. The electrolyte solution according to claim 1, wherein the onium cation (a) is an amidinium cation.

7. The electrolyte solution according to claim 6, wherein the amidinium cation is an imidazolinium cation or an imidazolium cation.

8. The electrolyte solution according to claim 7, wherein the amidinium cation is at least one cation selected from the groups consisting of the 1,2,3,4-tetramethylimidazolinium cation, the 1-ethyl-2,3-dimethylimidazolinium cation and the 1-ethyl-3-methylimidazolium cation.

9. An electrolytic capacitor herein the electrolyte solution defined in claim 1 is used therein.
